(19) United States
(12) Patent Application Publication
(10) Pub. No.: US 2005/0060874 A1
(43) Pub. Date: Mar. 24, 2005

(54) Method for processing work piece including magnetic material and method for manufacturing magnetic recording medium

(75) Inventors: Mikiharu Hibi, Tokyo (JP); Kazuhiro Hattori, Tokyo (JP); Shuichi Okawa, Tokyo (JP); Takahiro Suwa, Tokyo (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 10/892,373

(22) Filed: Jul. 16, 2004

(30) Foreign Application Priority Data
Jul. 18, 2003 (JP) 2003-276571
Jun. 11, 2004 (JP) 2004-174263

(51) Int. Cl. G11B 5/127

(52) U.S. Cl. 29/603.13

(57) ABSTRACT

A method for processing a work piece including a magnetic material and a method for manufacturing a magnetic recording medium. With the use of these methods, the magnetic recording medium with fine magnetic properties, magnetic recording and reproducing equipment, and the like are efficiently manufactured by processing the work piece including the magnetic material by use of an oxidizing reactive gas and then certainly removing the oxidizing reactive gas. An NH₃ gas (a non-oxidized gas including hydrogen elements) is used as a cleaning gas. The cleaning gas is turned into plasma, and then a work piece is dry cleaned by use of the cleaning gas.

### BACKGROUND OF THE INVENTION

1. Field of the Invention

The present invention relates to a method for processing a work piece including a magnetic material and a method for manufacturing a magnetic recording medium. By these methods, for example, a magnetic recording medium such as a magnetic recording disc, magnetic recording and reproducing equipment such as a magnetic head, and the like are manufactured.

2. Description of the Related Art

In recent years, in the field of manufacturing a magnetic recording medium and magnetic recording and reproducing equipment, the importance of microprocessing technology of a magnetic material has increased in accordance with improvement in storage capacity, miniaturization, and the like.

In the magnetic recording medium such as a hard disc, for example, the areal density has been significantly improved due to refinements such as use of finer magnetic particles and changes of materials composing a recording layer. The improvement of the areal density by use of conventional improving methods like this, however, is approaching its limits. Accordingly, a discrete type of magnetic recording medium, in which a continuous recording layer (a magnetic material) is divided into many recording elements, is proposed (refer to, for example, Japanese Patent Laid-Open Publication No. Hei 9-97419) as a candidate for a magnetic recording medium which can realize further improvement in the areal density.

To use the magnetic recording medium with the high areal density, it is necessary to finely process a head accordingly.

As the microprocessing technology of the magnetic material, a method of reactive ion etching which is commonly used in the field of manufacturing a semiconductor is available. In the method of reactive ion etching, an oxidizing gas such as a halogen gas is used as a reactive gas. Reactive ion etching which uses a CO (carbon monoxide) gas or the like as the reactive gas is known as dry etching suitable for the magnetic material (refer to, for example, Japanese Patent Laid-Open Publication No. 2000-322710). In the case of using this reactive ion etching, the method of the reactive ion etching which uses the oxidizing gas as the reactive gas is available for processing a mask layer.

The oxidizing gas oxidizes the magnetic material, and degrades the properties of the magnetic material. The oxidizing gas also has the characteristic of corroding the magnetic material, and this tendency is especially strong in the halogen gas. To prevent the oxidation and corrosion of the magnetic material like this, it is necessary to remove the oxidizing gas cleaning a work piece. Cleaning is also necessary for removing minute particles occurring in processing and the like after the work piece has been processed. As for the cleaning of the work piece, a method of wet cleaning (refer to, for example, Japanese Patent Laid-Open Publication No. Hei 12-91290) commonly used in the field of manufacturing a semiconductor and a method of dry cleaning (refer to, for example, Japanese Patent Laid-Open Publication No. Hei 4-75324) using a cleaning gas such as oxygen are available.

When the method of wet cleaning is used, however, a drying process and the like become necessary, so that there is a problem that the manufacturing efficiency is reduced. When both of a wet process and a dry process such as the dry etching are used, the conveyance of the work piece and the like become complicated, so that the manufacturing efficiency is further reduced. Furthermore, there is also a problem that the use of the wet cleaning tends to cause the intrusion of foreign materials into minute clearances in magnetic material.

On the other hand, the foregoing problems associated with the wet cleaning can be solved by use of the dry cleaning, but there are cases that the dry cleaning cannot adequately remove the oxidizing gas and the like.

In some cases, the oxidizing gas and the like can be adequately removed by making cleaning time longer, but it needs a great deal of time, and hence there is a problem in view of the manufacturing efficiency. Furthermore, when, for example, oxygen is used as the cleaning gas, the cleaning gas may oxidize the magnetic material due to the reaction with the magnetic material, so that there is also a problem that the degradation in the properties of the magnetic material and the corrosion of the magnetic material contrarily progress.

### SUMMARY OF THE INVENTION

In view of the foregoing problems, various exemplary embodiments of this invention provide a method for processing a work piece including a magnetic material and a method for manufacturing a magnetic recording medium. With the use of these methods, the work piece including the magnetic material is processed by use of an oxidizing gas and then the oxidizing gas is certainly and efficiently removed so that the magnetic recording medium, magnetic recording and reproducing equipment, and the like with fine magnetic properties can be efficiently manufactured.

Various exemplary embodiments of the invention achieve the certain and efficient removal of an oxidizing reactive gas by dry cleaning the work piece using a non-oxidized gas including hydrogen elements such as, for example, ammonia as a cleaning gas, as the cleaning gas after the cleaning gas is turned into plasma, using the cleaning gas.

Accordingly, various exemplary embodiments of the invention provide

A method for processing a work piece, including a magnetic material, comprising the steps of:
processing a work piece including a magnetic material by reactive ion etching using an oxidizing gas as a reactive gas; and
dry cleaning the magnetic material by use of a non-oxidized gas including hydrogen elements as a cleaning gas after the cleaning gas is turned into plasma.

The various exemplary embodiments of this invention bring about a beneficial effect that it becomes possible to efficiently manufacture a magnetic recording medium, magnetic recording and reproducing equipment, and the like with fine magnetic properties, because an oxidizing reactive gas and the like can be certainly removed.

### BRIEF DESCRIPTION OF THE DRAWINGS

Various exemplary embodiments of the present invention will be described in detail with reference to the accompanying drawings, wherein:

FIG. 1 is a sectional view schematically showing the configuration of a intermediate product of a sample according to a first exemplary embodiment of this invention;

FIG. 2 is a sectional view schematically showing the configuration of a completed product of the sample which is obtained by processing the intermediate product;

FIG. 3 is a side view partly including a block diagram which schematically shows the configuration of a reactive ion etching device used for processing the sample;

FIG. 4 is a flowchart showing the process of processing the sample;

FIG. 5 is a sectional view showing the shape of the sample in which a resist layer is divided;

FIG. 6 is a sectional view schematically showing the shape of the sample in which a second mask layer in the bottoms of grooves is removed;

FIG. 7 is a sectional view schematically showing the shape of the sample in which a first mask layer in the bottoms of the grooves is removed;

FIG. 8 is a sectional view schematically showing the shape of the sample in which a magnetic thin film layer is divided;

FIG. 9 is a flowchart showing the process of processing a sample according to a second exemplary embodiment of this invention;

FIG. 10 is a graph showing the magnetic curves of a sample before cleaning according to an example 1 of this invention;

FIG. 11 is a graph showing the magnetic curves of the sample after cleaning;

FIG. 12 is an optical microscope image which shows the enlarged surface of the sample after a high-temperature and high-humidity test;

FIG. 13 is an optical microscope image which shows the enlarged surface of a sample after the high-temperature and high-humidity test according to a comparative example 1; and

FIG. 14 is an optical microscope image which shows the enlarged surface of a sample after the high-temperature and high-humidity test according to a comparative example 2.

### DETAILED DESCRIPTION OF PREFERRED EMBODIMENTS

Various exemplary embodiments of this invention will be hereinafter described in detail with reference to the drawings.

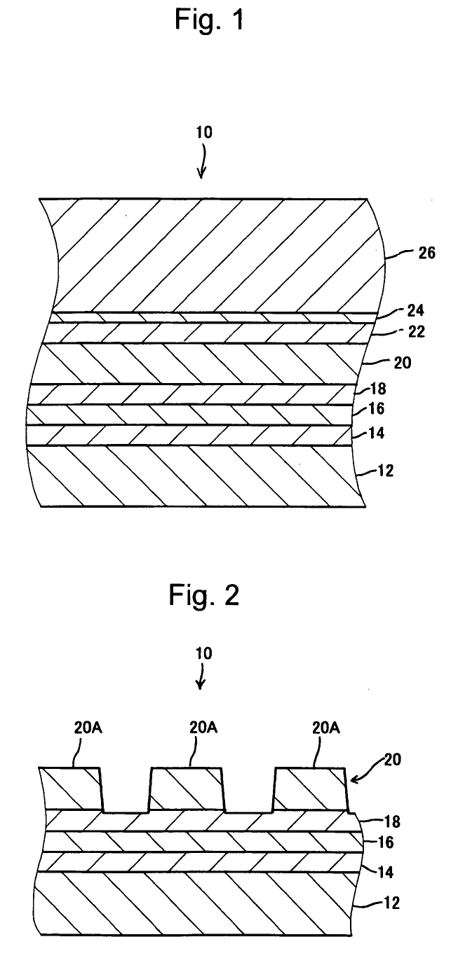

In a first exemplary embodiment of this invention, a sample (a work piece) including a magnetic thin film layer (a magnetic material) as shown in FIG. 1 is subjected to processing such as reactive ion etching which uses SF₆ (an oxidizing halogen gas) as a reactive gas, in order to process the magnetic thin film layer into the shape of a predetermined line-and-space pattern as shown in FIG. 2. The first exemplary embodiment of this invention is characterized by its cleaning process after a processing process. The other configuration does not seem very important to understand the first exemplary embodiment, so that description thereof will be appropriately omitted.

A intermediate product of a sample 10 has a structure in which a underlayer 14, a soft magnetic layer 16, seed layer 18, a magnetic thin film layer 20, a first mask layer 22, a second mask layer 24, and a resist layer 26 are laminated in this order over a glass substrate 12.

The underlayer 14 having a thickness of 30 to 2000 nm is made of Cr (chromium) or a Cr alloy.

The soft magnetic layer 16 having a thickness of 50 to 300 nm is made of a Fe (iron) alloy or a Co (cobalt) alloy.

The seed layer 18 having a thickness of 3 to 30 nm is made of CoO (cobalt oxide), MgO (magnesium oxide), NiO (nickel oxide), or the like.

The magnetic thin film layer 20 having a thickness of 5 to 30 nm is made of a CoCr (cobalt-chromium) alloy.

The first mask layer 22 having a thickness of 3 to 20 nm is made of TiN (titanium nitride).

The second mask layer 24 having a thickness of 3 to 15 nm is made of Ni (nickel).

The resist layer 26 having a thickness of 30 to 300 nm is made of an electron beam resist (ZEP520 of ZEON Corporation).

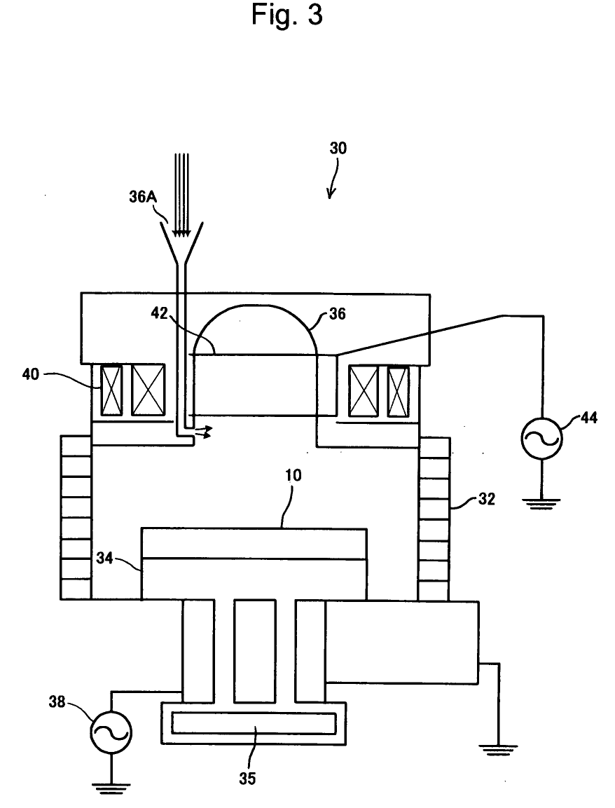

The sample 10 is processed by use of a reactive ion etching device as shown in FIG. 3 and the like.

A reactive ion etching device 30, which is of a helicon wave plasma system, includes a diffusion chamber 32, an ESC (electrostatic chuck) stage electrode 34 for mounting the sample 10 inside the diffusion chamber 32, and a quartz bell jar 36 for generating plasma.

The ESC stage electrode 34 is connected to a bias supply 38 for supplying bias voltage.

The bias supply 38 is an alternating-current power supply with a frequency of 1.6 MHz.

The quartz bell jar 36 is hemispheric, and its bottom is open to the inside of the diffusion chamber 32, and an inlet 36A for supplying a reactive gas is provided in the vicinity of the bottom end. A magnet coil 40 and an antenna 42 are disposed around the quartz bell jar 36. The antenna 42 is connected to a plasma generating source 44. The plasma generating source 44 is an alternating-current power supply with a frequency of 13.56 MHz.

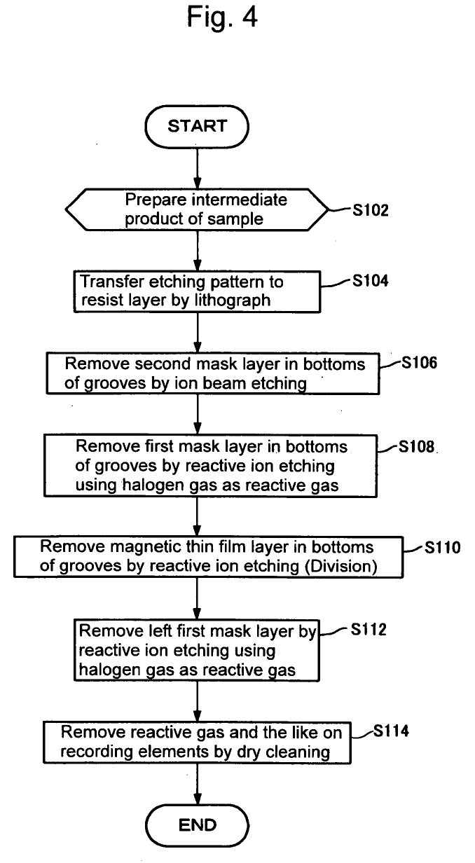

Then, a method for processing the sample 10 will be described along a flowchart shown in FIG. 4.

First, the intermediate product of the sample 10 shown in FIG. 1 is prepared (S102). The intermediate product of the sample 10 is obtained by forming the underlayer 14, the soft magnetic layer 16, the seed layer 18, the magnetic thin film layer 20, the first mask layer 22, and the second mask layer 24 in this order on the glass substrate 12 by sputtering, and then applying the resist layer 26 by spin coating.

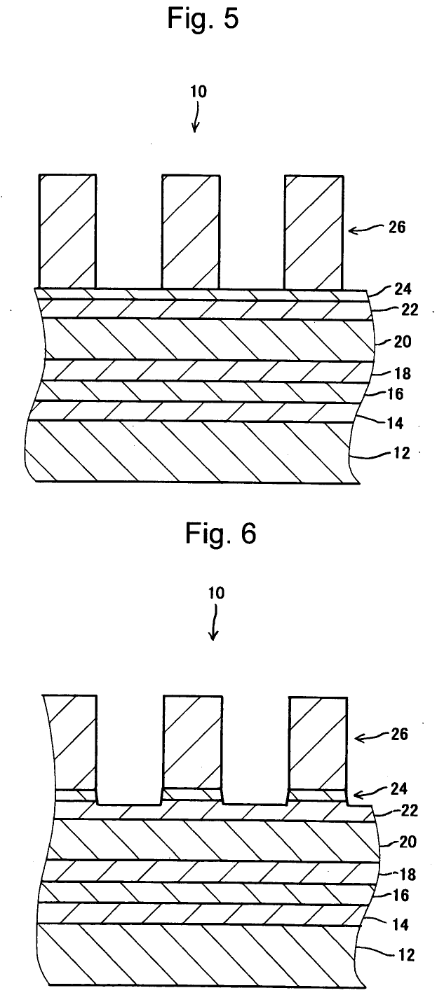

The resist layer 26 in the intermediate product of the sample 10 is exposed by use of an electron beam exposure device (not illustrated), and then the resist layer 26 is developed for five minutes by use of ZED-N50 (ZEON Corporation) at ambient temperature to remove exposed portions. Thus, as shown in FIG. 5, many grooves are formed at minute intervals (S104).

Then, by use of an ion beam etching device (not illustrated) using an Ar (argon) gas, the second mask layer 24 in the bottoms of the grooves is removed as shown in FIG. 6 (S106).

At this time, the resist layer 26 in areas except for the grooves is slightly removed.

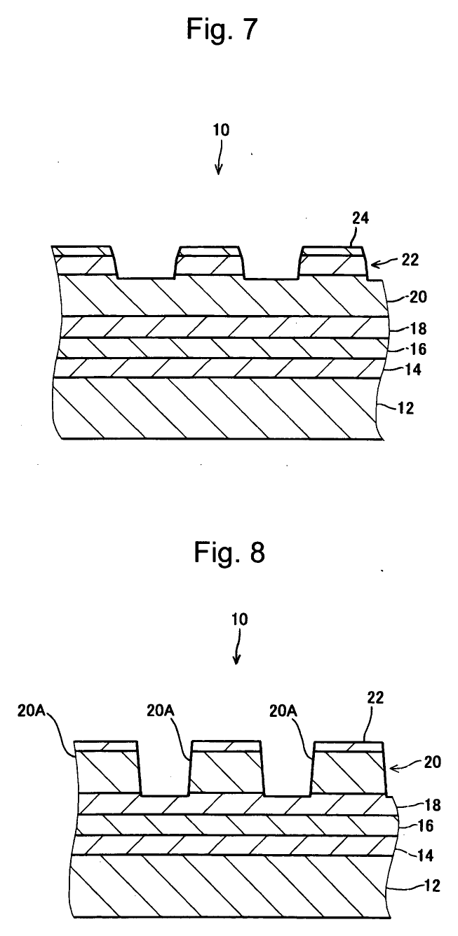

Then, by use of the reactive ion etching device 30, the first mask layer 22 in the bottoms of the grooves is removed as shown in FIG. 7 by the reactive ion etching which uses the SF₆ gas (an oxidizing halogen reactive gas) (S108) as the reactive gas.

To be more specific, the sample 10 is mounted and fixed on the ESC stage electrode 34, and the bias voltage is applied thereto. Furthermore, when the magnet coil 40 generates a magnetic field and the antenna 42 generates a helicon wave, the helicon wave propagating along the magnetic field generates high-density plasma inside the quartz bell jar 36. Supplying the SF₆ gas through the inlet 36A, radicals diffused inside the diffusion chamber 32 adhere to the surface of the first mask layer 22 and react. Also, ions induced by the bias voltage collide with the samples 10, to remove the surface of the first mask layer 22.

Thus, the magnetic thin film layer 20 is exposed from the bottoms of the grooves. At this time, the resist layer 26 in the areas except for the grooves is completely removed. The second mask layer 24 in the areas except for the grooves is partly removed, but a small amount thereof is left.

Then, as shown in FIG. 8, the magnetic thin film layer 20 in the bottoms of the grooves is removed by use of the reactive ion etching device 30 (S110).

To be more specific, when a CO gas and an NH₃ gas are supplied through the inlet 36A, instead of the SF₆ gas in the reactive ion etching (S108) of the first mask layer 22 described above, radicals diffused inside the diffusion chamber 32 carbonylate the surface of the magnetic thin film layer 20. Also, ions induced by the bias voltage remove the surface of the carbonylated magnetic thin film layer 20. Therefore, the magnetic thin film layer 20 is divided into many recording elements 20A.

The second mask layer 24 in the areas except for the grooves is completely removed by this reactive ion etching. The first mask layer 22 in the areas except for the grooves is partly removed, but a certain amount thereof is left on the top faces of the recording elements 20A.

Then, with the use of the reactive ion etching device 30, the first mask layer 22 left on the top faces of the recording elements 20A is completely removed by the reactive ion etching using the SF₆ gas (S112).

Then, the recording elements 20A are cleaned by use of the reactive ion etching device 30 (S114). To be more specific, the NH₃ gas (a non-oxidized gas including hydrogen elements) is supplied through the inlet 36A as a cleaning gas, instead of the SF₆ gas in the removal (S112) of the first mask layer 22 described above. Then, the NH₃ gas is turned into plasma. Radicals of the NH₃ gas diffused inside the diffusion chamber 32 remove the SF₆ gas on the surfaces of the recording elements 20A. The NH₃ gas is a reducing agent because it includes hydrogen. Also, the NH₃ gas is not oxide, the reducing power thereof is accordingly strong. Furthermore, the NH₃ gas is activated by being turned into the plasma, so that the reducing power is further strengthened. Therefore, it is possible to efficiently remove the oxidizing SF₆ gas, oxide on the surfaces of the recording elements 20A, and the like.

The NH₃ gas turned into the plasma does not react with the recording elements 20A, so that the recording elements 20A are not degraded.

The processing of the sample 10 shown in FIG. 2 is completed in this manner.

Since the recording elements 20A are cleaned by use of the NH₃ gas turned into the plasma, as described above, it is possible to certainly remove the reactive gas even if the reactive ion etching with the halogen gas as the reactive gas is employed. Therefore, it is possible to certainly manufacture a magnetic recording medium, magnetic recording and reproducing equipment, and the like with fine magnetic properties.

Since the NH₃ gas used as the cleaning gas is turned into the plasma, the reactive gas can be rapidly removed. Therefore, it is possible to increase the manufacturing efficiency of the magnetic recording medium, the magnetic recording and reproducing equipment, and the like.

Then, a second exemplary embodiment of this invention will be described.

With respect to the first exemplary embodiment, the second exemplary embodiment is characterized in that oxygen (an oxidizing gas) is used as a reactive gas instead of the halogen gas for processing and removing the first mask layer 22. In the second exemplary embodiment, the materials for the first and second mask layers 22 and 24, and a method for processing a magnetic thin film layer 20 differ from those of the foregoing first exemplary embodiment. The other things are the same as those of the first exemplary embodiment, the description thereof will be appropriately omitted.

In the second exemplary embodiment, the first mask layer 22 is made of C (carbon), and the second mask layer 24 is made of Si (silicon). The thickness of the first mask layer 22 is 3 to 20 nm, and the thickness of the second mask layer 24 is 3 to 15 nm, as in the case of the foregoing first exemplary embodiment.

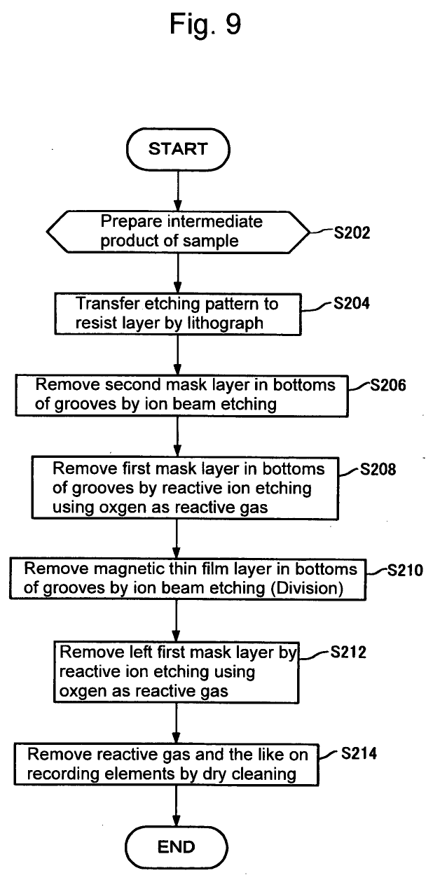

Then, a method for processing a sample 10 according to the second exemplary embodiment will be described along a flowchart shown in FIG. 9.

First, as in the case of the foregoing first exemplary embodiment, a intermediate product of the sample 10 is prepared (S202). Then, an etching pattern is transferred to a resist layer 26 by lithography as shown in FIG. 5 (S204), and the second mask layer 24 in the bottoms of grooves is removed as shown in FIG. 6 by ion beam etching (S206).

Then, with the use of a reactive ion etching device 30, the first mask layer 22 in the bottoms of the grooves is removed as shown in FIG. 7 by reactive ion etching which uses an O₂ gas (an oxidizing gas) as the reactive gas (S208).

The O₂ gas is activated by being turned into plasma, in addition to having a strong property of oxidizing carbon, so that the first mask layer 22 in the bottoms of the grooves is removed in a short period of time.

Then, as shown in FIG. 8, the magnetic thin film layer 20 in the bottoms of the grooves is removed by ion beam etching which uses a noble gas such as an Ar gas as a processing gas. Hence the magnetic thin film layer 20 is divided into many recording elements 20A (S210).

Then, by use of the reactive ion etching device 30, the first mask layer 22 left on the top faces of the recording elements 20A is completely removed by the reactive ion etching using the O₂ gas (S212).

Then, the recording elements 20A are cleaned with the use of the reactive ion etching device 30 (S214). To be more specific, an NH₃ gas (a non-oxidized gas including hydrogen elements) is supplied through an inlet 36A as a cleaning gas, instead of the O₂ gas in the removal (S212) of the first mask layer 22 described above. Then, the NH₃ gas is turned into plasma. Radicals of the NH₃ gas diffused inside a diffusion chamber 32 remove the O₂ gas on the surfaces of the recording elements 20A. Therefore, it is possible to efficiently remove the oxidizing O₂ gas, the oxide on the surfaces of the recording elements 20A, and the like.

The NH₃ gas turned into the plasma does not react with the recording elements 20A, so that the recording elements 20A are not degraded.

The processing of the sample 10 shown in FIG. 2 is completed in this manner.

Even when the first mask layer 22 is made of the carbon and the oxygen is used as the reactive gas for processing the first mask layer 22, as described above, it is possible to certainly remove the reactive gas by means of cleaning the recording elements 20A with the use of the NH₃ gas turned into the plasma. Therefore, it is possible to certainly manufacture a magnetic recording medium, magnetic recording and reproducing equipment, and the like with fine magnetic properties.

In the first exemplary embodiment, the SF₆ gas is used as the reactive gas in the reactive ion etching for processing the first mask layer 22. Even when the first mask layer 22 is processed by use of another halogen reactive gas such as, for example, another fluorine gas including a CF₄ gas and a chlorine gas, it is possible to efficiently remove the reactive gas, the oxide, and the like on the surfaces of the recording elements 20A by using the NH₃ gas turned into the plasma as the cleaning gas.

In the foregoing second exemplary embodiment, the O₂ gas is used as the reactive gas in the reactive ion etching for processing the first mask layer 22. Even when the first mask layer 22 is processed with the use of another oxidizing reactive gas such as, for example, an O₃ gas, it is possible to efficiently remove the reactive gas, the oxide, and the like on the surfaces of the recording elements 20A by using the NH₃ gas turned into the plasma as the cleaning gas.

In the foregoing first and second exemplary embodiments, the reactive ion etching using the oxidizing gas as the reactive gas is employed for processing the first mask layer 22. When the reactive ion etching, which uses the oxidizing gas as the reactive gas, is used for processing another layer such as, for example, the second mask layer 24 and the magnetic thin film layer 20, it is possible to efficiently remove the reactive gas, the oxide, and the like on the surfaces of the recording elements 20A by using the NH₃ gas turned into the plasma as the cleaning gas.

In the foregoing first and second exemplary embodiments, the NH₃ gas is used as the cleaning gas. Even when another non-oxidized gas including hydrogen elements such as, for example, a hydrogen gas, a mixture of the hydrogen gas and a nitrogen gas, an olefinic hydrocarbon gas such as ethylene and propylen, and an acetylenic hydrocarbon gas is used as the cleaning gas (with being turned into plasma), it is possible to efficiently remove the reactive gas, the oxide, and the like on the surfaces of the recording elements 20A.

Furthermore, a mixture of these gases may be used as the cleaning gas. Furthermore, a mixture of these gases, and an inert gas such as a noble gas, and/or a non-oxidized gas which does not have effect on a work piece such as a nitrogen gas may be used as the cleaning gas. These gases also have the strong reducing power because these gases include hydrogen and do not include oxide. Incidentally, it is possible to strengthen reducing power when these gases are activated by being turned into plasma. Therefore, it is possible to efficiently remove the oxidizing reactive gas such as the halogen gas including the SF₆ gas, the O₂ gas and the O₃ gas, the oxide, and the like on the surfaces of the recording elements 20A.

In the first exemplary embodiment, the CO gas with the NH₃ gas is used as the reactive gas of the reactive ion etching for processing the magnetic thin film layer 20. The magnetic thin film layer 20 may be processed by use of another gas such as a CO gas with a gas including a nitrogen compound such as an amine gas having the function of restraining the decomposition of CO, and a halogen gas as the reactive gas. Also, as described in the foregoing second exemplary embodiment, the magnetic thin film layer 20 may be processed by the ion beam etching which uses the noble gas such as the Ar gas as the processing gas.

In the foregoing first and second exemplary embodiments, the reactive ion etching device 30 of the helicon wave plasma system is used for processing the magnetic thin film layer 20 and the first mask layer 22 and cleaning the recording elements 20A. A reactive ion etching device of another type such as a parallel plate type, a magnetron type, a two-frequency excitation type, an ECR (electron cyclotron resonance) type and an ICP (inductively coupled plasma) type may be used instead.

In the foregoing first exemplary embodiment, the processing of the first mask layer 22, the processing of the magnetic thin film layer 20, the removal of the first mask layer 22, and the cleaning of the recording elements 20A are carried out by the common reactive ion etching device 30, but a part or the whole of these processes may be carried out by different devices. A device except for the reactive ion etching device may be used for cleaning the recording elements 20A, as long as the device generates plasma.

In the foregoing first and second exemplary embodiments, the resist layer 26 and the second mask layer 24 are formed over the first mask layer 22, and the second mask layer 24 is formed into the predetermined pattern by use of the electron beam exposure device and the ion beam etching. Materials for the mask layer and the resist layer over the first mask layer 22, a method for processing and the number of lamination are not specifically limited, as long as the second mask layer with etching resistance to the oxidizing reactive gas can be formed on the first mask layer 22 with high precision. As a method for forming the grooves in the resist layer 26 at minute intervals, for example, a nano-imprinting method may be used instead of the electron beam exposure device.

In the foregoing first and second exemplary embodiments, the magnetic thin film layer 20 is made of the CoCr alloy. Also in a case where a work piece including a magnetic material made of another material such as, for example, alloys of iron group elements(Co, Fe(iron) and Ni) and layered products thereof is processed by the reactive ion etching using the oxidizing gas as the reactive gas, it is possible to efficiently remove the reactive gas, the oxide, and the like on the surfaces of the recording elements 20A by using the non-oxidized gas including hydrogen elements (with being turned into the plasma) as the cleaning gas.

In the foregoing first and second exemplary embodiments, the underlayer 14, the soft magnetic layer 16 and the seed layer 18 are formed under the magnetic thin film layer 20. The configuration of the layers under the magnetic thin film layer 20 is appropriately changeable in accordance with the type of magnetic recording medium. For example, one or two layers of the underlayer 14, the soft magnetic layer 16, and the seed layer 18 may be omitted. Otherwise, the magnetic thin film layer 20 may be formed directly on the substrate.

In the foregoing first and second exemplary embodiments, the sample 10 is a test sample, but, as a matter of course, these exemplary embodiments are applicable to the processing of various recording mediums and devices which have a magnetic material such as a magnetic disc including a hard disc, magneto-optical disc, a magnetic tape, and a magnetic head.

### EXAMPLE 1

Fifty samples 10 were manufactured in accordance with the foregoing first exemplary embodiment. To be more specific, a hundred intermediate products of the samples 10 were prepared, and recording elements 20A having a width of approximately 250 nm were formed at intervals of approximately 300 nm in a minute pattern processing area the width of which was approximately 50 μm (refer to FIG. 8). Then, a first mask layer 22 left on the top faces of the recording elements 20A was removed by reactive ion etching using a SF₆ gas. At this time, the conditions of a reactive ion etching device 30 were adjusted as follows:
Flow rate of the SF₆ gas: 20 sccm
Pressure in the diffusion chamber: 1 Pa
Source power: 1000 W
Bias power: 50 W

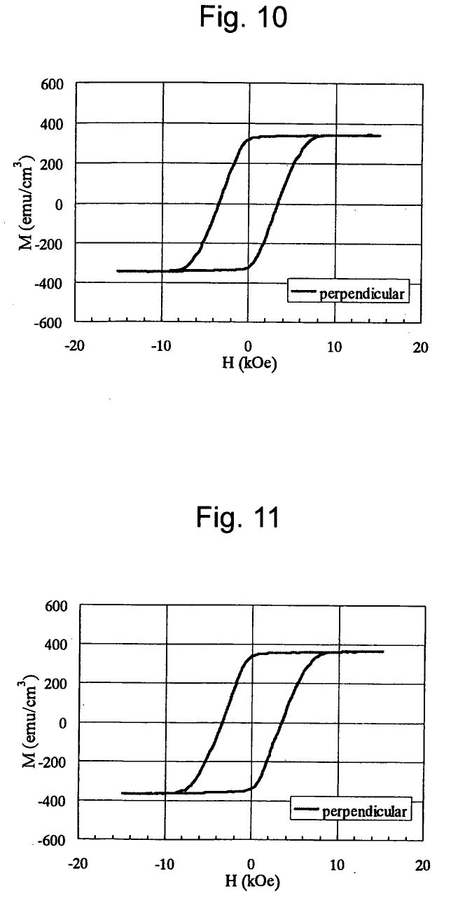

Then, fifty samples 10 were taken out of the reactive ion etching device 30 to measure magnetic properties by magneto-optic Kerr effect measurement. Any of the samples 10 had magnetic curves as shown in FIG. 10. In FIG. 10, a horizontal axis represents an external magnetic field H, and a vertical axis represents magnetization M.

The other fifty samples 10 were continuously held in the reactive ion etching device 30. Then, as described in the foregoing first exemplary embodiment, an NH₃ gas supplied to the reactive ion etching device 30 was turned into plasma to dry clean the samples 10. At this time, the conditions of the reactive ion etching device 30 were adjusted as follows:
Flow rate of the NH₃ gas: 50 sccm
Pressure in the diffusion chamber: 1 Pa
Source power: 1000 W
Cleaning time: approximately 60 seconds

The samples 10 obtained in such a manner were set in a constant temperature oven, which was kept at high-temperature and high-humidity environment of a temperature of 80 degrees centigrade and a humid of 80 percent for approximately forty hours.

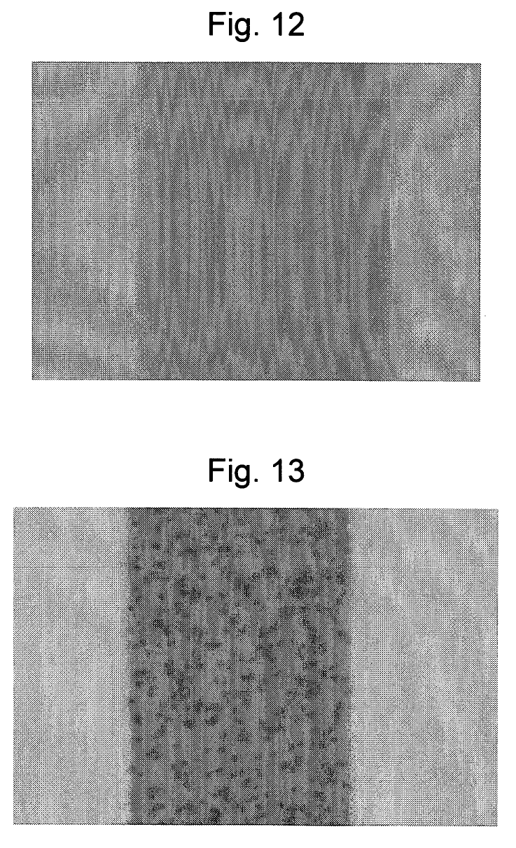

Then, the magnetic properties of the samples 10 were measured again by the magnetooptic Kerr effect measurement. Any of the samples 10 had magnetic curves as shown in FIG. 11.

Referring to FIGS. 10 and 11, there is no difference between the magnetic properties of the samples 10 before being cleaned by the NH₃ gas turned into the plasma and the magnetic properties of the samples 10 after being cleaned. Therefore, it was verified that degradation in the recording elements 20A by cleaning did not occur.

It was also verified that degeneration such as corrosion did not occur in the surface of the minute pattern processing area in any sample 10. By way of example, FIG. 12 is an optical microscope image which shows the enlarged surface of the minute pattern processing area of the single sample 10 after set in the constant temperature oven for approximately forty hours.

### COMPARATIVE EXAMPLE 1

With respect to the above example 1, fifty samples 10 were manufactured without carrying out cleaning after the first mask layer 22 left on the top faces of the recording elements 20A was removed by the reactive ion etching using the SF₆ gas. The samples 10 were set in the constant temperature oven, which was kept at high-temperature and high-humidity environment of a temperature of 80 degrees centigrade and a humid of 80 percent for approximately forty hours.

In any of the samples 10, it was verified that many spots indicating corrosion appeared in the surface of the minute pattern processing area. By way of example, FIG. 13 is an optical microscope image which shows the enlarged surface of the minute pattern processing area of the single sample 10 after being set in the constant temperature oven for approximately forty hours.

### COMPARATIVE EXAMPLE 2

With respect to the above example 1, fifty samples 10 were manufactured by removing the first mask layer 22 left on the top faces of the recording elements 20A by the reactive ion etching using the SF₆ gas, and dry cleaning them by use of a supplied NH₃ gas without being turned into plasma for approximately thirty minutes. These samples 10 were set in the constant temperature oven, which was kept at high-temperature and high-humidity environment of a temperature of 80 degrees centigrade and a humid of 80 percent, for approximately forty hours.

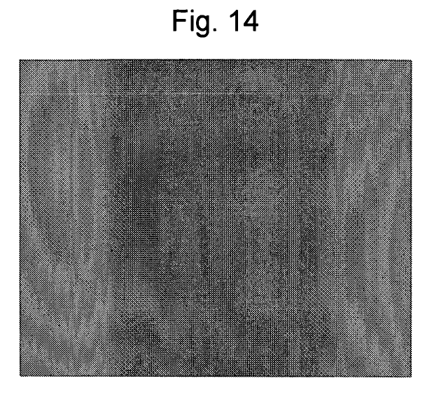

In any of the samples 10, it was verified that plural spots indicating corrosion, the number of which is lower than that of the comparative example 1 though, appeared in the surface of the minute pattern processing area. By way of example, FIG. 14 is an optical microscope image which shows the enlarged surface of the minute pattern processing area of the single sample 10 after being set in the constant temperature oven for approximately forty hours.

### EXAMPLE 2

Fifty samples 10 were manufactured in accordance with the foregoing second exemplary embodiment. To be more specific, fifty intermediate products of the samples 10 were prepared, and recording elements 20A having a width of approximately 250 nm were formed at intervals of approximately 300 nm in a minute pattern processing area the width of which was approximately 50 μm (refer to FIG. 8). Then, a first mask layer 22 left on the top faces of the recording elements 20A was removed by reactive ion etching using an O₂ gas. At this time, the conditions of the reactive ion etching device 30 were adjusted as follows:
Flow rate of the O₂ gas: 50 sccm
Pressure in the diffusion chamber: 1 Pa
Source power: 1000 W

Furthermore, as described in the foregoing second exemplary embodiment, an NH₃ gas supplied to a reactive ion etching device 30 was turned into plasma to dry clean the samples 10. At this time, the conditions of the reactive ion etching device 30 were adjusted as follows:
Flow rate of the NH₃ gas: 50 sccm
Pressure in the diffusion chamber: 1 Pa
Source power: 1000 W
Cleaning time: approximately 50 seconds

Then, the coercivity Hc of the recording elements 20A of the samples 10 obtained in this manner was measured by a VSM (vibrating sample magnetometer). When measurement results were compared with that of an unprocessed sample, there was no difference in the coercivity Hc. In other words, it was verified that degradation in the coercivity of a magnetic thin film layer 20 did not occur when the sample 10 was dry cleaned by the NH₃ gas, even if the sample 10 was processed by use of the O₂ gas as a reactive gas.

### COMPARATIVE EXAMPLE 3

With respect to the above example 2, samples 10 were manufactured without carrying out cleaning after the first mask layer 22 left on the top faces of the recording elements 20A was removed by the reactive ion etching using the O₂ gas. Then, the coercivity of the recording elements 20A was measured by the VSM. In any of the samples 10, magnetic properties (coercivity) were degraded. Table 1 shows the measurement results (average values of the fifty samples) of the coercivity of the recording elements 20A according to the example 2 and the comparative example 3, in contrast with the measurement result of the coercivity of an unprocessed sample.

TABLE 1

| | Coercivity Hc(kOe) |
|---|---|
| Unprocessed Sample | 3.26 |
| Example 2 | 3.25 |
| Comparative Example 3 | 2.37 |

Various exemplary embodiments of this are applicable to the manufacture of a magnetic recording medium, magnetic recording and reproducing element, and the like.

1. A method for processing a work piece, including a magnetic material, comprising the steps of:
processing a work piece including a magnetic material by reactive ion etching using an oxidizing gas as a reactive gas; and
dry cleaning the magnetic material by use of a non-oxidized gas including hydrogen elements as a cleaning gas after the cleaning gas is turned into plasma.

2. The method for processing a work piece, including a magnetic material according to claim 1, wherein
in the step of dry cleaning, a gas including at least one of an ammonia gas, a hydrogen gas, a mixture of the hydrogen gas and a nitrogen gas, an olefinic hydrocarbon gas, and an acetylenic hydrocarbon gas is used as the cleaning gas.

3. The method for processing a work piece, including a magnetic material according to claim 1, wherein
in the step of processing, a gas including at least one of a halogen gas, oxygen, and ozone is used as the oxidizing gas.

4. The method for processing a work piece, including a magnetic material according to claim 2, wherein
in the step of processing, a gas including at least one of a halogen gas, oxygen, and ozone is used as the oxidizing gas.

5. A method for manufacturing a magnetic recording medium, comprising:
the step of processing a magnetic recording medium including a magnetic layer by use of the method for processing a work piece including a magnetic material according to claim 1.

6. A method for manufacturing a magnetic recording medium, comprising:
the step of processing a magnetic recording medium including a magnetic layer by use of the method for processing a work piece including a magnetic material according to claim 2.

7. A method for manufacturing a magnetic recording medium, comprising:
the step of processing a magnetic recording medium including a magnetic layer by use of the method for processing a work piece including a magnetic material according to claim 3.

8. A method for manufacturing a magnetic recording medium, comprising:
the step of processing a magnetic recording medium including a magnetic layer by use of the method for processing a work piece including a magnetic material according to claim 4.
